(19) United States
(12) Patent Application Publication
(10) Pub. No.: US 2010/0217478 A1
(43) Pub. Date: Aug. 26, 2010

(54) TELEMATICS-BASED VEHICLE STATUS MONITORING AND CUSTOMER CONCERN RESOLVING

(75) Inventors: YILU ZHANG, Northville, MI (US); MARK J. RYCHLINSKI, Farmington Hills, MI (US); NATHAN D. AMPUNAN, Novi, MI (US); YUEN-KWOK CHIN, Troy, MI (US); KRISHNARAJ INBARAJAN, Troy, MI (US); MUTASIM A. SALMAN, Rochester Hills, MI (US); PAUL W. LOEWER, South Lyon, MI (US); MARK E. GILBERT, Ann Arbor, MI (US); SHIRLEY B. DOST, Canton, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., DETROIT, MI (US)

(21) Appl. No.: 12/391,862

(22) Filed: Feb. 24, 2009

(51) Int. Cl. G06F 19/00

(52) U.S. Cl. 701/33

(57) ABSTRACT

A system and method for monitoring the state of health of vehicle components, sub-systems and systems on board the vehicle and/or remotely, and use collected information and data about the vehicle to establish a database for the vehicle as to the state of health of the various components, sub-systems and systems. When a customer brings a vehicle to a service center or dealership complaining about a particular problem, and the service center wishes to replace a part associated with that problem, the OEM or manufacturer can authorize or reject the replacement of the part based on review of the database as to the known state of health of the part. Therefore, only parts which may not be healthy will typically be authorized for replacement. Also, the database can be made available to customers for customer concern resolving.

### BACKGROUND OF THE INVENTION

1. Field of the Invention

This invention relates generally to a system and method for monitoring the state of health of vehicle components, sub-systems and systems and, more particularly, to a system and method for providing vehicle health monitoring telematically from a remote location so as to monitor the health of vehicle systems and sub-systems to identify vehicle problems to provide warranty screening and customer concern resolution.

2. Discussion of the Related Art

Warranty costs for vehicle parts is a huge expense for vehicle manufacturers and OEMs (original equipment manufacturer). One of the most significant warranty costs is known in the art as no trouble found (NTF). An NTF typically starts with a customer complaining about a particular abnormal condition, such as intermitate loss of torque, battery discharge, etc., in the vehicle, and the dealer, OEM or supplier is not able to replicate the problem identified by the customer. Particularly, when the vehicle is brought to the dealer for service, the dealer runs standard tests, but is not able to replicate the condition. The dealer may then replace a certain part on the vehicle, such as the battery, hoping that that is the part that is not operating properly. The dealer then will return the part to the OEM or manufacturer along with the warranty claim that is paid by the OEM or manufacturer.

Analysis of many of these parts that are returned to the OEM or manufacturer under NTF conditions have shown that the part is actually healthy and in good working order. Therefore, the dealer replaced the part that was not the root cause of the problem complained by the customer. This practice results in a significant cost in transportation expense, testing man-power, part replacement, etc. Therefore, only a vary small portion of the warranty claims can be audited because of the cost.

Another current practice requests dealers to call an OEM service center and answer specific questions before a part under warranty is authorized to be replaced. This practice is also restricted by manpower. Further, the phone audit does not rely on tangible evidence to present dealership misconduct.

### SUMMARY OF THE INVENTION

In accordance with the teachings of the present invention, a system and method are disclosed for monitoring the state of health of vehicle components, sub-systems and systems on board the vehicle and/or remotely, and use collected information and data about the vehicle to establish a database for the vehicle as to the state of health of the various components, sub-systems and systems. When a customer brings a vehicle to a service center or dealership complaining about a particular problem, and the service center wishes to replace a part associated with that problem, the OEM or manufacturer can authorize or reject the replacement of the part based on review of the database as to the known state of health of the part. Therefore, only parts which may not be healthy will typically be authorized for replacement. Also, the database can be made available to customers for customer concern resolving.

Additional features of the present invention will become apparent from the following description and appended claims, taken in conjunction with the accompanying drawings.

### BRIEF DESCRIPTION OF THE DRAWINGS

FIG. 1 is an illustration of a vehicle including an on-board module for monitoring vehicle components and a back-office module that receives information from the vehicle concerning the state of health of vehicle components;

FIG. 2 is a flow chart diagram showing a process for providing vehicle part state of health estimation;

FIG. 3 is a flow chart diagram showing a process for warranty screening; and

FIG. 4 is a flow chart diagram showing a process for providing customer concern resolving.

### DETAILED DESCRIPTION OF THE EMBODIMENTS

The following discussion of the embodiments of the invention directed to a system and method for collecting and storing information concerning the state of health of vehicle parts and using that information in a database to determine whether parts will be replaced is merely exemplary in nature, and is in no way intended to limit the invention or its applications or uses.

As will be discussed in detail below, the present invention proposes a system and method that collects data and information about various components, sub-systems and systems on a vehicle either on the vehicle itself and/or remotely at a back-office, and provides a database storing the collected data for the particular vehicle. Various state of health monitoring algorithms can be employed to analyze the data and determine the state of health of the particular component, sub-system or system, which would also be stored in the database. The database can then be used by the dealership that may be servicing the vehicle to determine the state of health of various components, an OEM who may be considering a warranty claim by the dealership or other service center as to authorization to replace a particular part, and/or the customer himself when they subscribe to the database to determine if certain problems can be easily resolved without the customer having to go to the dealership or service center.

Various vehicle components, sub-systems and systems typically have their own algorithms for monitoring their state of health that may issue a trouble code if a certain problem is detected. Further, algorithms are known in the art that receive the various diagnostics and trouble codes from the vehicle components, sub-systems and systems, and use this information to determine a broader state of health of the vehicle and its components. Therefore, data and algorithms already exists in the art that can be used to determine the state of health of various vehicle components, sub-systems and systems.

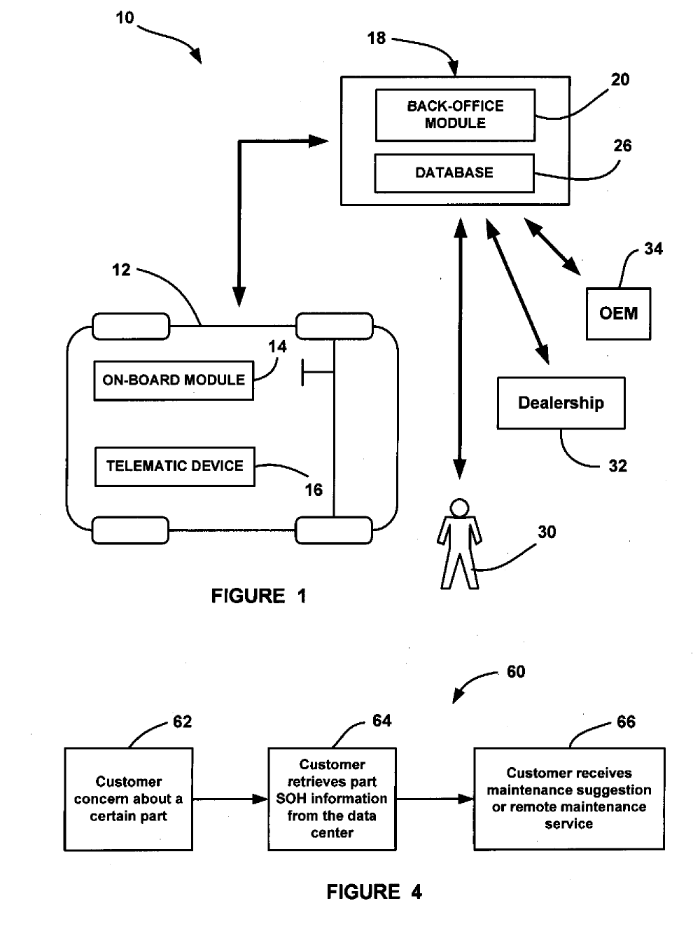

FIG. 1 is an illustration of a system 10 that collects and transmits vehicle data and information concerning the state of health of various vehicle components, such as a battery, generator, etc., and uses that information in state of health algorithms to determine the state of health of those components, sub-systems and systems. The vehicle 12 includes an on-board module 14 that receives the various vehicle information and data relating to the vehicle components, sub-systems and systems, and may run state of health algorithms on the information and data received, store results from the state of health monitoring, store the raw vehicle data itself, etc., depending on the processing capability and algorithms provided on the on-board module 14. Additionally, information from the various vehicle components, sub-systems and systems can be transmitted to a remote data center 18 including a back-office module 20 which may include additional processing power beyond what is available on the vehicle 12. The information from the vehicle 12 can be transmitted telematically by any suitable technique, such as through a satellite system, cell-phone system, etc., that is suitable and available for the particular system being implemented. The back-office module 20 may also perform state of health processing on the information and data received from the vehicle 12 and store the analysis of the components, sub-systems and systems in a database 26 for that particular vehicle.

The information stored at the data center 18 in the database 26 can then be accessed by any or all of a customer 30, a dealership 32 or an OEM 34. The term customer as used herein is intended to represent any designated person that may subscribe to the data center 18 and may be authorized to receive information from the data center 18 for a particular vehicle. The customer 30 may want to access the information to see if there is a particular problem with his vehicle depending on some condition experienced by the customer 30 before the customer 30 takes the vehicle 12 to the dealership 32 to be serviced. This may prevent the customer 30 from having to go through the time and expense of taking the vehicle 12 to the dealership 32. Various problems, such as an abnormal drain on the vehicle battery, can be identified by the customer 30, who can take suitable action to prevent the battery drain, such as removing external power draining sources from the battery that the customer 30 may have plugged into the power receptacle in the vehicle 12. The dealership 32 can access the information in the database 26 to determine a cause of problems on the vehicle 12 when the customer 30 does bring it into the dealership 32. The OEM 34 can authorize warranty claims, such as replacement of parts, requested by the dealership 32 based on whether the OEM 34 determines if the part requested to be replaced is healthy from the information stored in the database 26.

If certain criteria are met based on the vehicle status evaluated from uploaded vehicle data, for example, battery state of health is high, but battery state of charge is low, the customer concern may be resolved through authorized remote vehicle operation, such as remote vehicle start and charge the discharged battery. The battery state of health may be uploaded to the data center 18 once every month from each vehicle that is under warranty. Since battery state of health usually does not change dramatically within a short period of time, a monthly report is usually enough to represent the battery status between two consecutive reports. If the most recent three reports indicate a good battery health for a particular vehicle, where the criteria can be further tuned, the warranty claim of replacing the battery may be rejected.

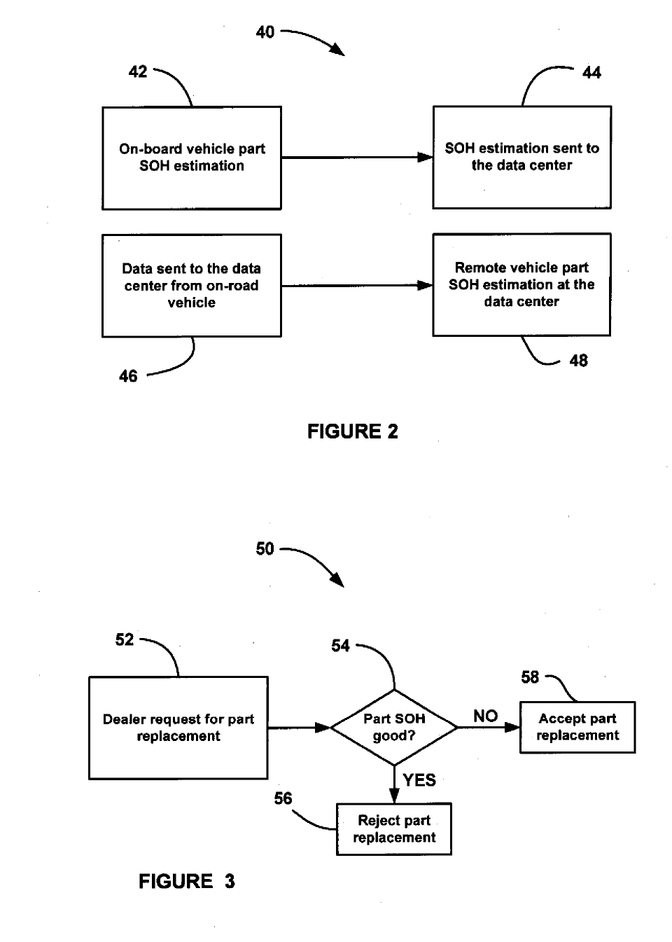

FIG. 2 is a flow chart diagram 40 showing a process for determining state of health estimation of a vehicle part as discussed above. At box 42, the on-board module 14 provides a vehicle part state of health estimation using any suitable algorithm that is provided in the on-board module 14. This state of health estimation is then sent to the data center 18 where it is stored in the database 26 at box 44. Alternately, or concurrently, vehicle data is sent to the data center 18 from the vehicle 12 at box 46, which may include vehicle identification number, parametric or abstract vehicle data, timestamp, etc., and the data center 18 may use the back-office module 20 to determine vehicle state of health estimation, which is also stored in the database 26 at box 48.

FIG. 3 is a flow chart diagram 50 showing a process for warranty screening, as discussed above. At box 52, the dealer requests a part replacement that is under warranty from the data center 18 or other OEM center. The data center 18 will determine if the part state of health is good at decision diamond 54 from the stored data in the database 26 and the estimation of the state of health performed by the back-office module 20. If the part state of health is good at the decision diamond 54, then the OEM 34 may reject the part replacement request at box 56, and if the part state of health is not good at the decision diamond 54, then the OEM 34 may approve the part replacement request at box 58.

FIG. 4 is a flow chart diagram 60 showing a process for customer concern resolving. At box 62, the customer may have concerns about a particular vehicle part that he has experienced, such as a weak battery. The customer can then access state of health information from the data center 18 at box 64 to determine whether the particular part state of health is good if the customer 30 is authorized to do so. Based on the request from the customer, the data center 18 may provide maintenance suggestions or provide remote service, such as charging the battery at box 66.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for collecting and storing data concerning vehicle parts, said method comprising:
collecting data relating to vehicle parts on the vehicle;
collecting data relating to vehicle parts at a remote data center;
running state of health algorithms on the collected data to provide state of health analysis of the vehicle parts either on the vehicle or at the remote data center;
storing information about the vehicle parts and their state of health at the remote data center; and
using the stored information to accept or reject warranty claims about the vehicle parts.

2. The method according to claim 1 wherein the state of health analysis of the vehicle parts is performed both on the vehicle and at the remote data center.

3. The method according to claim 1 wherein the stored information at the remote data center is made available to a vehicle owner.

4. The method according to claim 3 wherein the vehicle owner can request information about a vehicle part from the remote data center.

5. The method according to claim 3 further comprising performing remote maintenance service on the vehicle part based on a customer's request.

6. The method according to claim 5 wherein the remote maintenance service remotely starts the vehicle to charge the battery.

7. The method according to claim 1 further comprising broadcasting the data from the vehicle to the remote data center in a wireless manner.

8. The method according to claim 1 further comprising allowing a dealership to access the information stored at the remote data center to determine the state of health of certain vehicle parts.

9. The method according to claim 1 wherein the data collected at the remote data center is raw data from the vehicle parts.

10. A method for collecting and storing data concerning vehicle parts, said method comprising:
collecting data relating to vehicle parts on the vehicle;
running state of health algorithms on the collected data on the vehicle;
telematically broadcasting the collected data and/or a state of health analysis of vehicle parts;
receiving and storing the collected data and/or state of health analysis information at a remote data center;
running state of health algorithms on the data received at the remote data center; and
providing the information stored at the remote data center to a customer, a dealership or an OEM.

11. The method according to claim 10 wherein the customer can request information about a vehicle part from the remote data center.

12. The method according to claim 11 further comprising performing remote maintenance service on the vehicle part based on a customer's request.

13. The method according to claim 10 wherein the OEM uses the information for warranty screening purposes.

14. The method according to claim 13 wherein the OEM uses the information to accept or reject a part replacement.

15. A vehicle system comprising:
a vehicle including an on-board module, said on-board module collecting data relating to vehicle parts and providing state of health analysis of the collected data for the vehicle parts, said vehicle further including a telematics unit for broadcasting messages including information concerning the collected data and the state of health analysis; and
a remote data center responsive to the telematic messages from the vehicle, said remote data center storing information and collecting data relating to the received messages and performing state of health analysis about the vehicle parts from the received information, said remote data center making the information available to a customer, a dealership or an OEM.

16. The system according to claim 15 wherein the customer can request information about a vehicle part from the remote data center.

17. The system according to claim 16 wherein the data center can perform remote maintenance service on the vehicle part based on a customers request.

18. The system according to claim 15 wherein the OEM uses the information for warranty screening purposes.

19. The system according to claim 18 wherein the OEM uses the information to accept or reject a part replacement.
